(19) United States
(12) Patent Application Publication
(10) Pub. No.: US 2002/0147633 A1
(43) Pub. Date: Oct. 10, 2002

(54) Interactive advertisement and reward system

(76) Inventor: Kambiz Rafizadeh, West Vancouver (CA)

Correspondence Address: BIRCH STEWART KOLASCH & BIRCH, PO BOX 747, FALLS CHURCH, VA, 22040-0747, US

(21) Appl. No.: 09/756,236

(22) Filed: Jan. 9, 2001

Related U.S. Application Data
(60) Provisional application No. 60/212,413, filed on Jun. 19, 2000.

(51) Int. Cl. G06F 17/60; G09B 3/00; G09B 7/00

(52) U.S. Cl. 705/14; 434/322; 705/10

(57) ABSTRACT

The invention provides an interactive system for providing product information and rewards to a consumer. The system is a business-to-business and business-to-consumer model which aggregates product information (goods or services) advertisements on a web site and provides rewards to consumers who browse product-specific advertisements. Consumers may receive rewards (either cash awards or product discounts) by browsing the advertisements (preferably in the form of an interactive catalogue) and answering product-specific questionaries and/or by providing post-sale feedback to the sellers of products. Advertisers benefit from the system by a low customer-acquisition cost of the model, the high quality of feedback and customer intelligence obtained and by the “ready-to-buy” profile obtained by consumers who are attracted to the web site's interactive catalogue.

### FIELD OF THE INVENTION

The invention provides an interactive system for providing product information and rewards to a consumer. The system is a business-to-business and business-to-consumer model which aggregates product information (goods or services) advertisements on a web site and provides rewards to consumers who browse product-specific advertisements. Consumers may receive rewards (either cash awards or product discounts) by browsing the advertisements (preferably in the form of an interactive catalogue) and answering product-specific questionaries and/or by providing post-sale feedback to the sellers of products. Advertisers benefit from the system by a low customer-acquisition cost of the model, the high quality of feedback and customer intelligence obtained and by the “ready-to-buy” profile obtained by consumers who are attracted to the web site's interactive catalogue.

### BACKGROUND OF THE INVENTION

The continued growth of the Internet is providing unique e-business opportunities for business-to-business and business-to-consumer transactions. The opportunities provided by the Internet for sellers to advertise and access consumers interested in their products and services are unparalleled in history in terms of scope. Primarily, these opportunities include the potential for market penetration resulting from the relatively low costs associated with operating and maintaining web-site based advertisements and the overall growth in Internet usage.

As a result of the relative youth of the Internet, the development and deployment of sophisticated and effective seller/consumer interactions over the Internet has yet to be developed. In particular, while the web has, to a limited extent, enhanced the ability for advertisers to develop larger markets for their products and services, they have not been able to effectively attract new consumers in a manner which benefits both the advertiser and the consumer. That is, while advertisers have the potential for making an impression on hundreds of millions of consumers, it remains difficult to specifically attract those consumers who may be interested in an advertiser's specific products. Current web based advertising systems include for example banners with animated features and/or various “click-on” capabilities or “registration” capabilities. A banner is limited as it is ignored by most users. Pages requiring registration are often limited by a user's lack-of-trust in providing personal information.

Accordingly, there has been a need for a web based advertisement system that encourages web users to selectively browse certain web sites over and above other web sites.

In order to enhance the ability of a web site to attract consumers, there has been a need for an advertisement system which rewards users of the system with real-world credits for i) reviewing product information, ii) providing feedback with respect to the effectiveness of the advertisement information iii) actual purchases of advertised products, iv) providing post-sale feedback concerning the product and v) introducing new users to the system.

Past systems have not provided these functions.

### SUMMARY OF THE INVENTION

In accordance with the invention, there is provided an interactive system for providing product information and rewards to a consumer comprising:

an electronic media element for providing product-specific facts to the consumer;

a question database engine operatively connected to the electronic media element, the question database engine including:

questions relating to the product-specific facts;

a module for displaying a selection of the questions to the consumer and for receiving and evaluating responses from the consumer to the selection of questions; and,

a reward manager operatively connected to the question database engine for calculating rewards for the consumer based on the responses received to the selection of questions.

In further embodiments, the rewards are any one of or a combination of a cash credit to the consumer or a discount credit for subsequent purchase of a product.

In a still further embodiment, the system provides a product sale module operatively connected to the reward manager, the product sale module for receiving rewards data from the reward manager and reporting the rewards data to a seller of a product operatively connected to the product sale module whereby the seller provides a discount to the consumer if the consumer has appropriate reward data for the product being purchased.

In a still further embodiment, the system provides a post-sale module operatively connected to the reward manager, the post-sale module for providing a post-sale questionnaire to a consumer and for receiving responses from the consumer to the post-sale questionnaire, the post-sale module also for reporting completion of the post-sale questionnaire to the reward manager for calculating a reward for the consumer specific to completing the post-sale questionnaire.

In yet a still further embodiment, the system includes a membership module operatively connected to the electronic media element, the membership module for receiving and managing member data and for controlling access to the question database. In a preferred embodiment, the membership module defines at least two levels of membership, a first level allowing access to the electronic media element and the second level allowing access to the question database.

In yet a further embodiment, the system includes a seller account for holding seller funds operatively connected to the reward manager wherein the seller account is debited when the reward manager provides a reward to the consumer.

In yet another embodiment, the system provides a membership referral module operatively connected to the membership module and the reward manager for providing referral data to the reward manager.

In accordance with another embodiment, the invention provides a method for providing product information and rewards to a consumer comprising the steps of:

a) providing an electronic media element containing product-specific facts to the consumer;

b) determining a selection of questions relating to the product-specific facts and providing the selection to the consumer;

c) receiving and evaluating answers to the selection of questions from the consumer;

d) crediting a consumer account with a reward if a pre-determined number of questions from step b) were correctly answered.

In another embodiment of the method, the reward is any one of or a combination of a cash credit to the consumer or a discount credit for subsequent purchase of a product.

In further embodiments of the method, the method may include the step of applying a discount credit from the consumer account against the purchase price of a product and/or the step of crediting the consumer account with a reward if the consumer completes a post-sale questionnaire.

### BRIEF DESCRIPTION OF THE DRAWINGS

These and other features of the invention will be more apparent from the following description in which reference is made to the appended drawings wherein:

FIG. 1 is an overview of the system in accordance with the invention;

FIG. 2A is a flow diagram showing details of a members/visitors playing a PIC;

FIG. 2B is a flow diagram showing details of member registration;

FIG. 2C is a flow diagram showing details of member activation;

FIG. 2D is a flow diagram showing details of a member answering a PIC questionnaire;

FIG. 2E is a flow diagram showing details of a member answering a PIC questionnaire and account crediting/debiting details;

FIG. 2F is a flow diagram showing details of a product sale;

FIG. 2G is a flow diagram showing details of a feedback questionnaire;

FIG. 2H is a flow diagram showing details of a month end account reconciliation;

FIG. 2I is a flow diagram showing details of optional notices; and,

FIGS. 2J and 2K are flow diagrams showing details of an escrow account transaction;

### DETAILED DESCRIPTION OF THE INVENTION

In accordance with the invention and with reference to the Figures, an interactive product review and reward system is described.

As an overview, the system is a business-to-business and business-to-consumer model which aggregates product information (goods or services) advertisements on a web site and provides rewards to consumers who browse product-specific advertisements. Consumers may receive rewards (either cash awards or product discounts) by browsing the advertisements (preferably in the form of an interactive catalogue) and answering product-specific questionaries and/or by providing post-sale feedback to the sellers of products. Advertisers benefit from the system by a low customer-acquisition cost of the model, the high quality of feedback and customer intelligence obtained and by the “ready-to-buy” profile obtained by consumers who are attracted to the web site's interactive catalogue.

In a preferred form, the advertisements on the system are electronic media elements, such as multi-media based presentations which may include a combination of video, audio, text and other components forming an interactive presentation, called private interactive communications (PICs). It is preferred that a PIC will include information in order to i) educate a consumer about the key features of a product or service; ii) identify what differentiates a particular product or service from a competitor's; and, iii) enable consumers to readily compare different products or services before buying. A PIC may also include customers' reviews of a product and/or access to customer service. Each PIC will also include a database of questions in a particular format including short answer, multiple choice or true/false.

Web Site

The interactive product review and reward system is preferably located on a web site although other wide-area network systems could be employed.

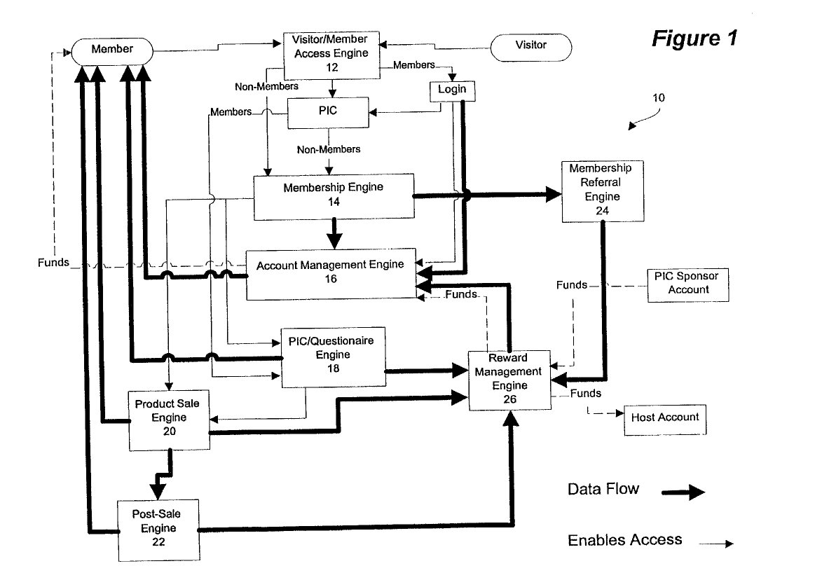

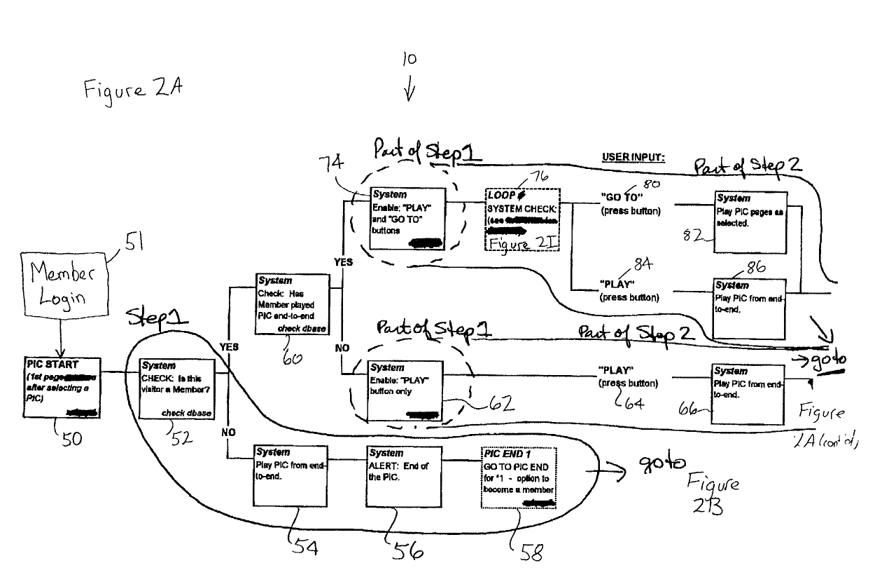

The embedded functionality of the web site as shown in the block diagram of FIG. 1 includes:

a) a visitor/member access engine 12

b) a member registration engine 14

c) an account management engine 16

d) a PIC/questionnaire engine 18

e) a product sale engine 20

f) a post-sale engine 22

g) a membership referral engine 24

h) a reward management engine 26.

The system is preferably implemented on a client-server computer network such as the world wide web.

Visitor/Member Access Engine

The visitor/member access engine enables visitors to the web site access to PICs. The web site may be structured in a variety of formats but will preferably enable or provide the following:

a) Product/Service Category Index

The product/service category index hierarchally indexes products/services by sector, general product/service-type, company and company-specific product/service. Table 1 shows the levels or indexing for an example of “Computer Products/Services”.

TABLE 1
Product/Service Index Levels

| Level | Name | Example |
|---|---|---|
| 1 | Alphabetical Index | “C” |
| 2 | Sector Index | “Computer Products and Services” |
| 3 | Company Index | “Dell” |
| 4 | Product/Service Index | “Portable Computers” |
| 5 | Products/Services | “Model D1000A” |
| 6 | Product/Service PIC | “Model D1000A PIC” |

b) Allow Previously Registered Members to Log into the System

Previously registered members upon accessing the home page of the system can log in immediately.

c) Allow Specific Keyword Searching for Direct Access and Linking to Any Level of the Index

Members/visitors can search for specific products or services by entering keywords to find specific PICs, companies, sectors, etc.

d) Allow a Member to Bookmark and Create Lists of Their Favourite PICs Which Can be Accessed Upon Login

Once a user has become a member, the system will preferably allow the member to create personalized lists of PICs which can be directly accessed by a bookmark file. In one embodiment, the system will automatically update PICs as they are updated by the advertisers.

Membership Engine

The member registration engine generally allows site visitors to enroll as members and thereby create member accounts. The member registration engine will preferably enable or perform the following:

a) Collection and storage of basic member information including name and contact coordinates; and,

b) Collection and storage of activated member information including credit card information Membership will preferably be separated into two categories, a basic member and an activated member. A basic member (likely someone new to the system who does not fully understand how the system works) may provide preliminary identifying information such as a user name, password and email address. The basic member will be able access a PIC for viewing but will not be able to access a PIC questionnaire and the reward system. An activated member will be fully registered in the system and will have provided full identifying information as well as a credit card number. The activated member will be able access a PIC questionnaire, the reward system, post-sale questionaries and other features of the system.

Account Management Engine

The account management engine generally receives data indicating that a member is active on the system. In addition the account management engine receives data from the reward management engine to enable the reward status of an account to be updated. The account management engine will preferably enable or perform the following:

a) Monitoring Site Usage Including PIC Usage

The account management engine will monitor the time and date of site usage and the time-spent on the site.

b) Collection and Storage of Reward Credits from PIC Usage

The account management engine will receive reward credit information based on an activated member reviewing a PIC and properly answering a PIC questionnaire.

c) Collection and Storage of Reward Credits from Product Purchases;

The account management engine will receive reward credit information based on an activated member purchasing a product from a registered seller.

d) Collection and Storage of Reward Credits from Post-Sale Questionaries;

The account management engine will receive reward credit information based on an activated member completing post-sale questionnaire.

e) Collection and Storage of Reward Credits from New-Member Referrals and New-Member Usage

The account management engine will receive reward credit information based on the activity of another member who was referred to the system by an activated member.

f) Provide Data to a Member Concerning Their Account Status.

The account management engine will provide information to an activated member concerning the activated member's account status either at the request of the member or by the system.

g) Limit the Amount of Rewards to a User Over a Time-Period

The account management engine will limit the total value of a financial reward to a member to a pre-determined maximum for a given period. For example, the member may be limited to earning a maximum of $10/day and/or $100/month.

PIC/Questionnaire Engine

The PIC/Questionnaire engine generally manages the activation of the interactive multi-media elements within a PIC and user access to PICs on the site. Within each PIC is a link to a PIC-specific question database including a number of questions directly relating to the PIC. PIC-specific questions are selectively displayed to a member according to a questionnaire display algorithm. The PIC/Questionnaire engine will preferably perform or enable the following:

a) Activation of a PIC on the Site Allowing Visitor/Member Access to the PIC

A PIC will be made active on the site if the account status of the PIC sponsor is current. In the event that a PIC sponsor's account does not contain sufficient funds, the PIC may or may not be displayed.

b) Creation of a Questionnaire for Display to an Activated Member After a PIC Has Been Played

Each PIC will contain a link to a database of PIC-specific questions which can be utilized to create a questionnaire by a questionnaire display algorithm within the system. For example, the PIC may contain 50 questions, a number of which can be randomly selected each day for creation of a day-specific questionnaire. Alternatively, questions could be selected by rotation or randomly through the list of questions to create a questionnaire.

c) Display of a Questionnaire to a Member

After a PIC has been played, if a basic member who thereafter activates their status to activated member status or an activated member requests that a questionnaire be displayed, the PIC/questionnaire engine will display a questionnaire.

d) Questionnaire Management

After an activated member has completed a PIC-specific questionnaire, the PIC/questionnaire engine will determine the “correctness” of the member's answers to the questionnaire. If a member has successfully completed the questionnaire, the PIC/questionnaire engine will report successful completion data to the reward management engine for calculation of a reward (cash credit for answering questionnaire and/or discount on product/service purchase). If a member has not correctly answered the questionnaire, the member may re-try the questionnaire (up to a pre-determined daily maximum) or exit. “Correctness” may be defined as correctly answering a given number of questions in the questionnaire. Correctness may mean correctly answering all questions in the questionnaire or correctly answering a certain percentage of questions. That is, in order to qualify for a reward, the system may state that 100% correctness is required or alternatively another percentage is required to qualify for the reward.

Product Sales Engine

The product sales engine provides access to sellers/providers allowing a member to purchase products services directly from the sellers/providers. Product providers linked to the system report sales data to the product/services sales engine for reporting to the reward management engine. The product/services sales engine will preferably provide or enable the following:

a) Access to Sellers/Providers

An activated member can directly access a seller's/provider's web site to make a product purchase or to redeem a coupon or to benefit from other offerings that may have been made available.

b) Searching Sellers/Providers

The product sale engine may include a cost-comparison algorithm enabling members to readily compare the prices of competing products. In addition, the product sale engine may also include algorithm(s) to compare other features of different products.

c) Providing Reward Credit Data to Sellers/Providers

The product sale engine, through the account management engine, may notify a seller/providers of any current credits or discounts in a member's account which may be applied to a purchase.

d) Collection and Management of Sales Data from Sellers/Providers

The product sale engine will receive information from a seller/provider that a sale has been completed for reporting to the reward management engine.

Post-Sale Engine

The post-sale engine utilizes sales data relating to a product sale stored within the account management engine to notify a member that they can answer a post-sale questionnaire. The post-sale engine will preferably generate a message which is sent to the user some time after the sale providing linked access to a questionnaire relating to the product. The member upon completion of the questionnaire receives a specific reward which is credited to their account for completion of the questionnaire. The post-sale engine will preferably provide or enable the following:

a) Providing Notification to a Member with Respect to Accessing a Post-Sale Questionnaire

The post-sale engine will contact a member at some time after a sale inviting them to complete a post-sale questionnaire. The post-sale questionnaire is preferably located on the system or may be accessed from the seller's/provider's site.

b) Managing or Receiving Post-Sale Questionnaire Completion Data

The post sale engine will receive and manage data relating to the completion of a post-sale questionnaire.

c) Reporting Post-Sale Questionaire Completion Data to the Reward Management Engine

If a post-sale questionaire has been properly completed, the post-sale engine will report that data to the reward management engine for determining the reward for the member for completing the post-sale questionaire.

Membership Referral Engine

The membership referral engine monitors data relating to new members who have been referred to the system by existing members. The membership referral engine utilizes usage data of new members and reports that data to the reward management engine for calculating bonus rewards to existing members based on the new member's usage of the system. The membership referral engine will preferably provide or enable the following:

a) Identification of New Members Who Have Been Referred to the System by an Existing Member

At the time new members register, if they indicate that an existing member referred them to the system, the membership referral engine will create a link between those members for crediting the referring member.

b) Reporting New Member Reward Data to the Existing Member Account for a Given Time Period

The membership referral engine will monitor the activity of the referred member for a given time period (for example, one year) and report that activity to the reward management engine.

Reward Management Engine

The reward management engine generally calculates reward data based on a member's site usage and reports reward data to the account management engine. The reward management engine will preferably perform or enable the following:

a) Receive Task Completion Data from the PIC/Questionaire Engine and Calculate Reward Data for Posting to a Member Account

The reward management engine will receive data that a member has completed a questionaire for a specific PIC and calculate the reward for completing the questionaire (for example $1.00 for completing the questionaire and a 10% discount to be applied against a PIC-specific product or service purchased within 30 days). The reward data will be credited to the member's account.

b) Receive Post-Sale Questionaire Completion Data from the Post-Sale Engine and Calculate Post-Sale Reward Data for Posting to a Member Account

The reward management engine will receive data that a member has completed a post-sale questionaire after a purchase and calculate the reward for completing the questionaire (for example $1.00). The reward data will be credited to the member's account.

c) Receive Member Referral Data from the Member Referral Engine and Calculate Referral Reward Data for Posting to a Member Account Based on a New Member's Reward Data.

The reward management engine will calculate referral reward data based on a referred member's system usage for a given time period (for example, one year).

d) Monitor System Usage by Activated Members

The system will limit the amount of rewards over a given time period. For example, daily and/or monthly maximums may be implemented.

Deployment Example

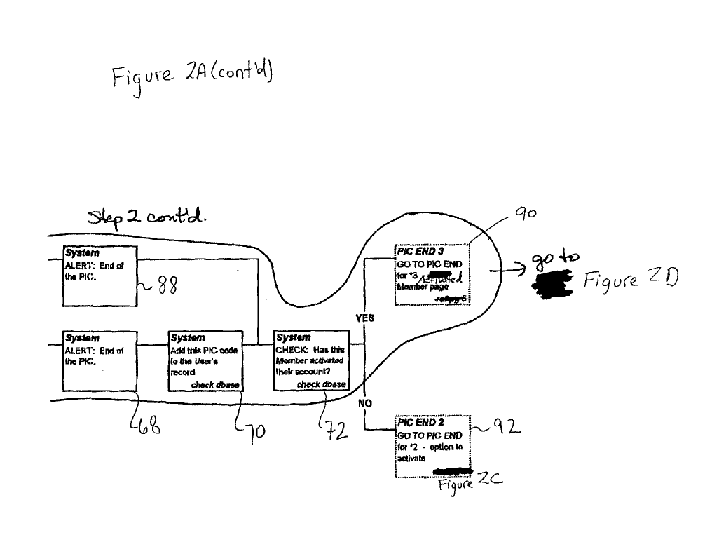

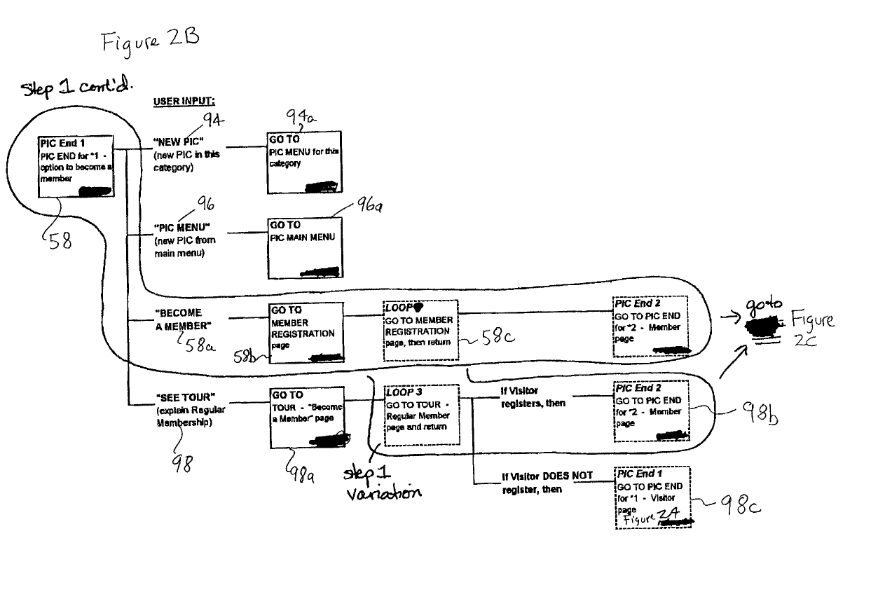

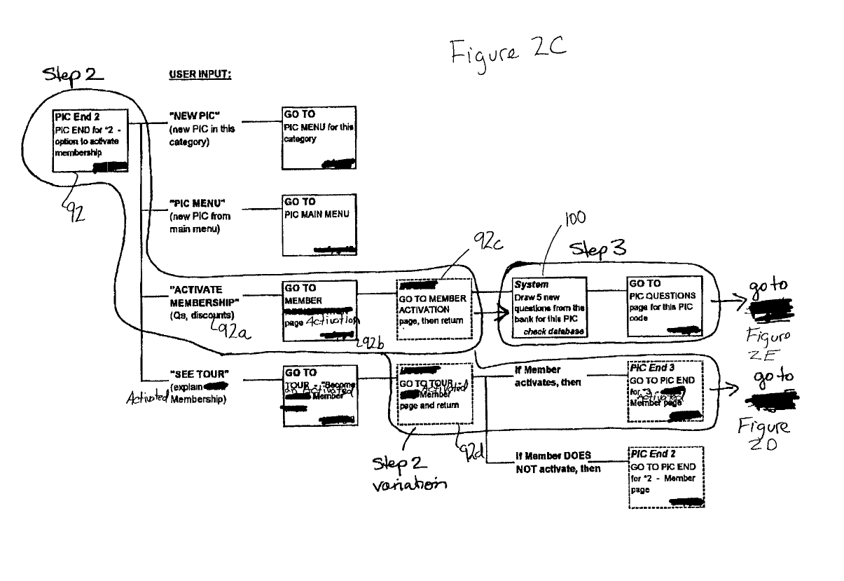

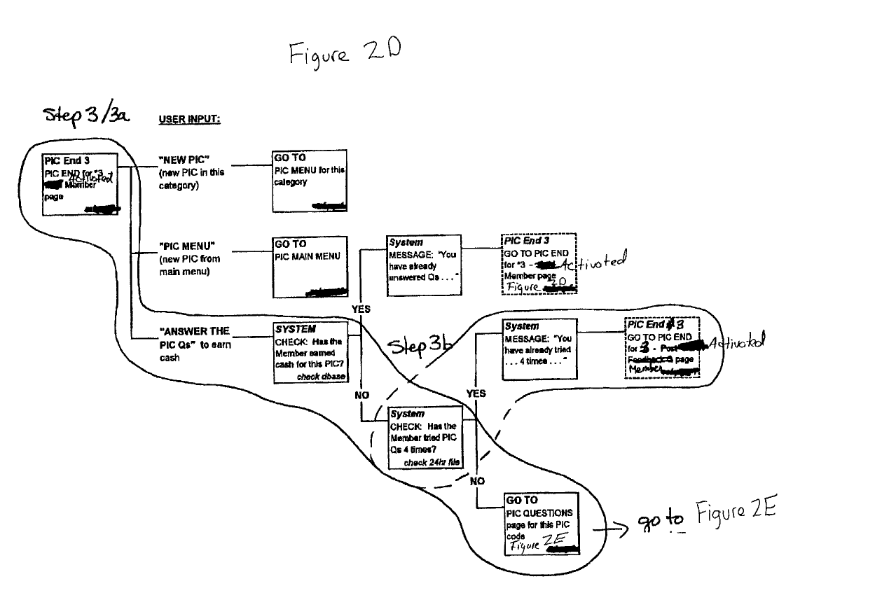

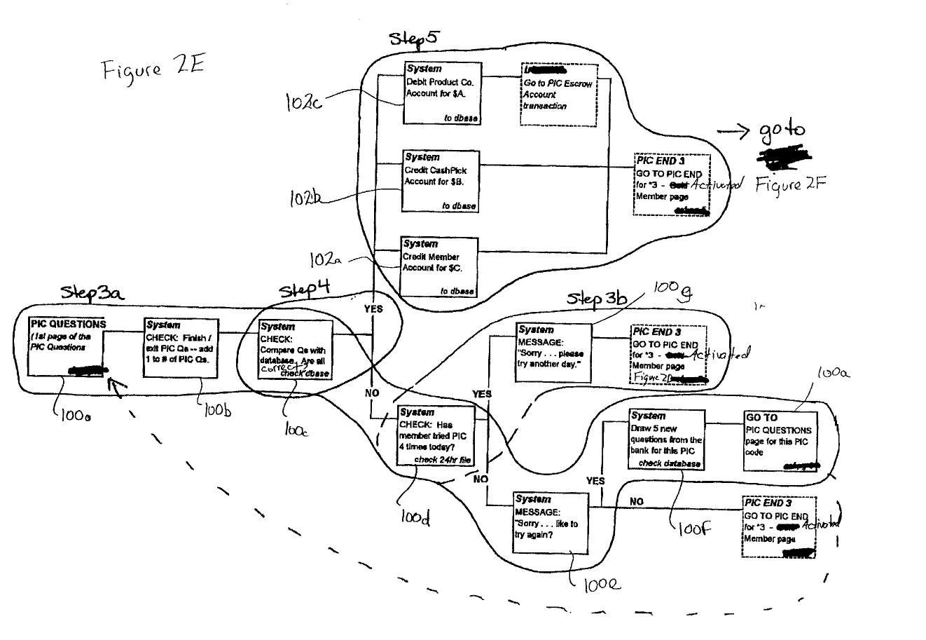

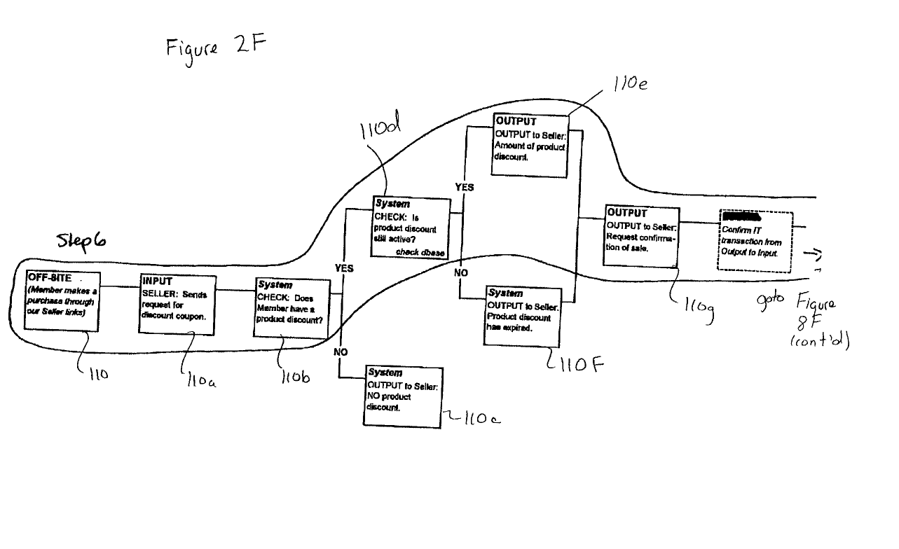

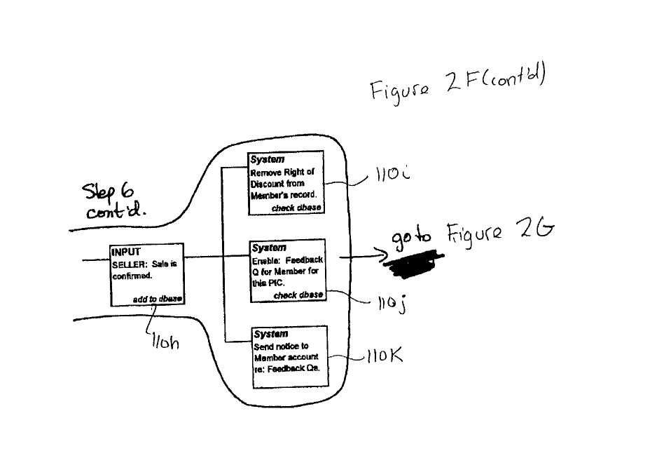

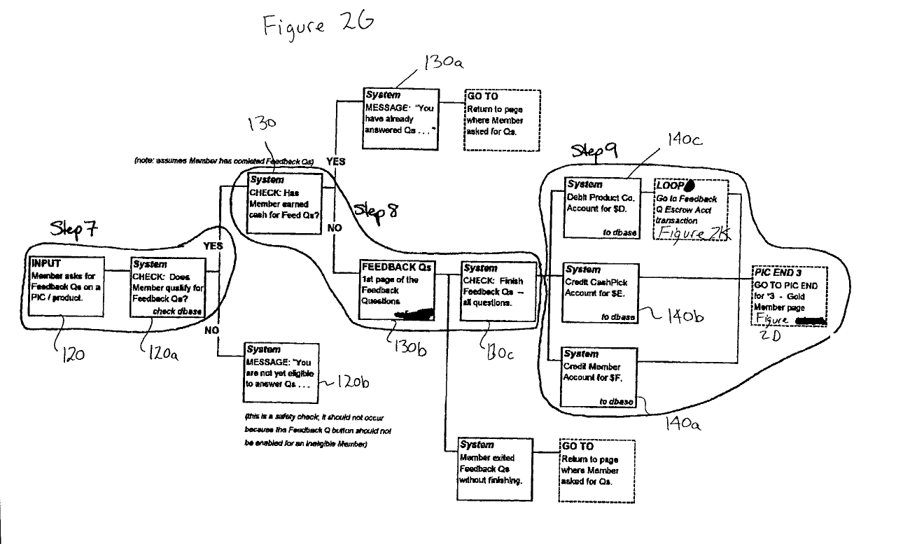

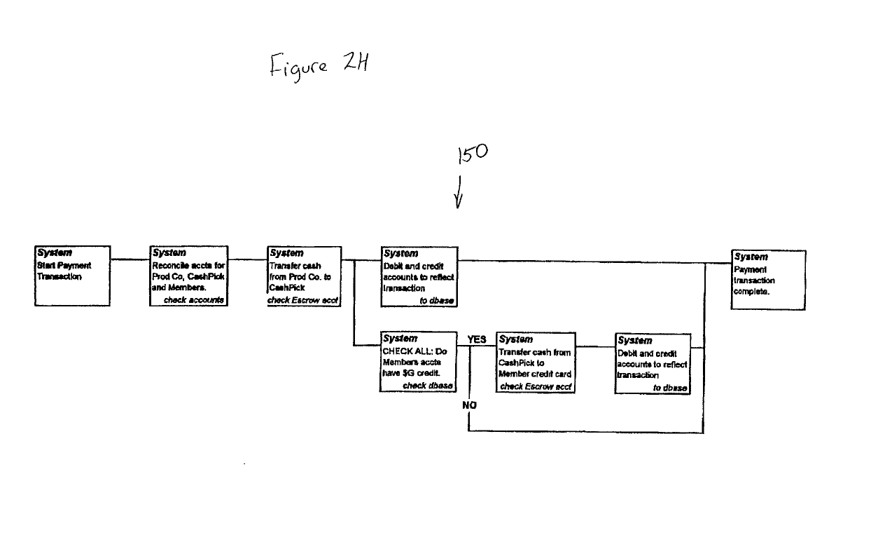

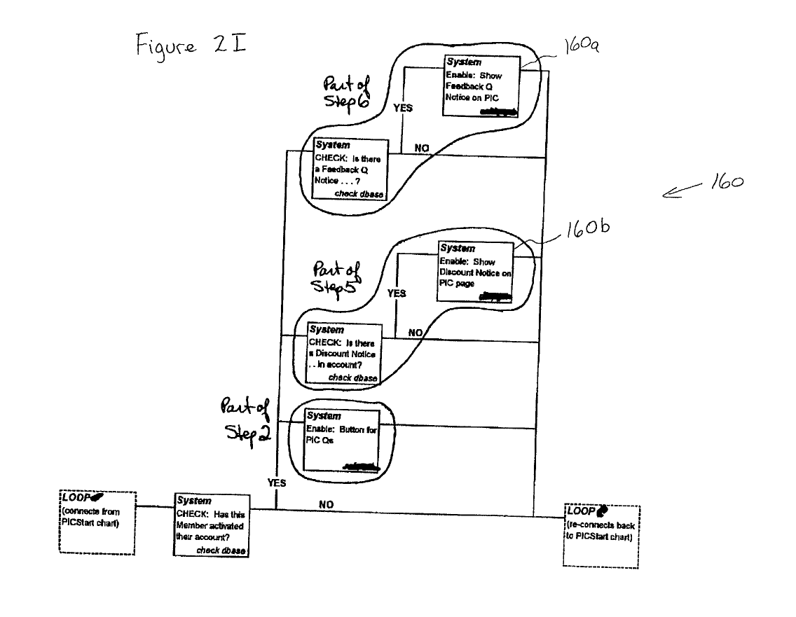

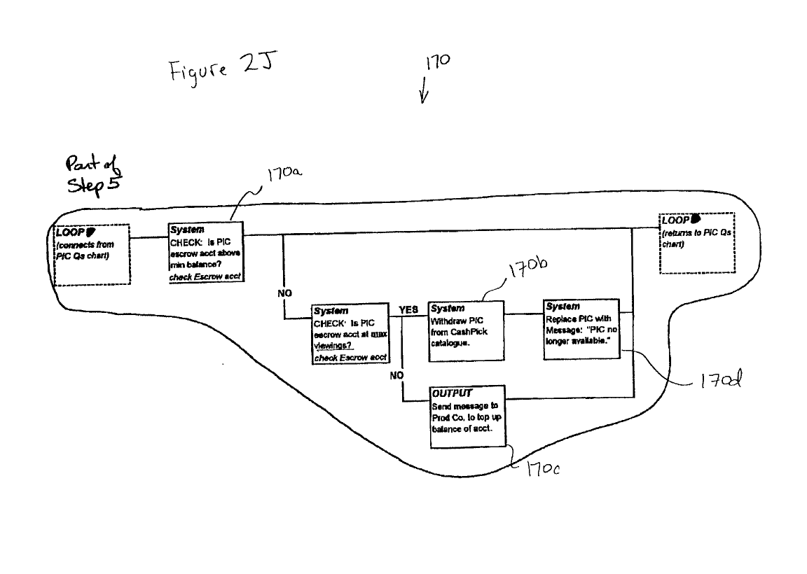

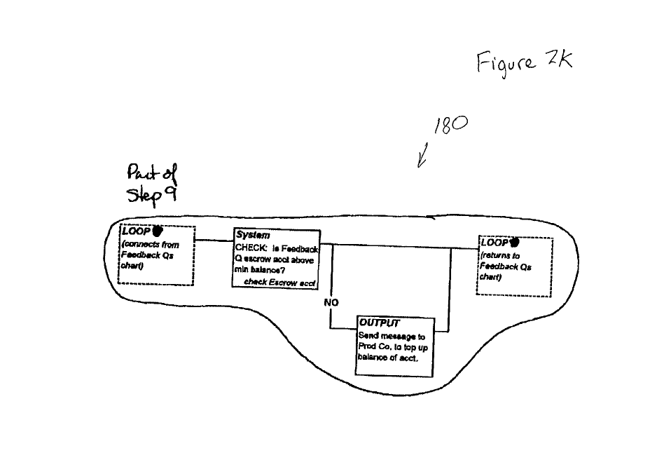

With reference to FIGS. 2A-2K, a sample deployment is outlined enabling a user to view a PIC, earn rewards after viewing the PICs and answering questionaires relating to the PICs as well as through making purchases of PIC specific products. It is understood that the system may be deployed in other formats as would be understood by those skilled in the art.

Login

At 51 (FIG. 2A) a member may log into the system 10 thereby notifying the system of the presence of a member and to enable monitoring of system and member usage.

Step 1—Visitor/Member Access and Membership

Members and visitors to the system select PICs of interest from a display of a PIC-specific icons or text. Selection of a specific PIC at 50 initiates a system check at 52 (FIG. 2A) which determines whether the visitor is a system member. If no, clicking a highlighted “play” button causes the PIC to be played 54 from start-to-finish. The system is alerted when the PIC presentation is finished 56. The system then alerts the visitor to the option of becoming a member 58 (see below).

From 58, the system displays the option of “Become a Member” 58a which, if selected, directs the visitor to a member registration page 58b (loop 2) which upon completion returns the user to 58c.

Other options, including the opportunity of viewing other PICs 94 which may be category specific 94a or selecting a new PIC from a menu 96, 96a may be provided. The system may still further provide a “tour” 98 which describes the general and specific operation of the system which may include links and loops to other system components including providing a tour and becoming a member 98a with variations depending on the whether the visitor chooses to become a member 98b or not 98c.

Step 2—Playing a PIC and Membership Activation

If at 51 (FIG. 2A), the user has logged in as a member, the system at 52 will confirm member status and check whether a selected PIC has been played from end to end at 60. If a selected PIC has not been played from end-to-end, as above, the system will highlight a “play” button only 62, whereby if the “play” button is pressed 64, the PIC will play from end-to-end. The system is alerted when the end of the PIC is reached 68 and a PIC-specific code is added to the member's account 70.

If at 60, the system check confirms that a PIC has been played from end-to-end, the system highlights both a “play” and a “goto” button 74 activating “loop 1” 76, 160 which checks account status. If the member presses “go to” 80, the system plays specific PIC pages as may be selected 82. If the member presses “play” 84, the PIC is played from end-to-end 86. Upon completion of 82 or 86 respectively, the system is alerted upon completion 88. Note that as the member has previously played the PIC from end-to-end, the PIC-specific code is already within the member's account.

If the system check at 72 confirms that the member has activated their account, the member is linked to an “Activated Member Page” 90. Alternatively, if the system check at 72 confirms that the member has not activated their account, the member is linked to a page enabling account activation 92 (FIG. 2C).

If at 92 (FIG. 2C) after viewing a PIC and the system determines that membership has not been activated, the member is presented with the option of “activate membership” 92b. If activated, 92c (loop 4), the member can proceed to step 3 where they can participate in the PIC Questionnaire process.

A variation is member activation from a tour 92d.

Step 3—Questionnaire

If membership is active, the system can select a number of questions from the PIC question database 100 (FIG. 2E) through steps 3 and 3a. Initially, a number of questions are displayed 100a which provide appropriate fields to allow the member enter their answers to the questions. The system checks whether the member has completed the questionnaire and if so provides system checks 100b and 100c. At 100b the system exits the PIC questions and internally records completion of that particular set of questions. At 100c the responses received are verified for accuracy. If the answers are incorrect 100d, the system checks whether the member has attempted the PIC questions a certain number of times that day (for example 4 times). If the member has not tried the questions 4 times 100e, the system will ask the member whether they would like to try again. If the member wishes to try again 100f, the system will select 5 new questions from the PIC question database and present the 5 new questions to the member 100a.

If the member has already tried the PIC questions 4 times 100g, the system will display a message indicating that the member must return on another day to retry the questions and the member is directed to the member page (FIG. 2D).

Step 4—Correct Answers to PIC Questions

If all PIC questions have been answered correctly 100c, step 5 is initiated.

Step 5—Account Management

If at 100c the system determines that all the questions have been answered correctly, the system will determine the appropriate credit amounts to be applied to the member's account 102a and the host account 102b and the appropriate debit to be applied to the PIC's sponsor account 102c.

Step 6—Product Sale

The system also enables off-site product sales 110 (FIG. 2F). If at the seller's site, a customer initiates a product purchase, the seller will request system information whether the purchaser is a member or not and subsequently to determine whether to provide a discount or not to the purchaser based on the member's discount credits. A system check 110b will determine if the member has a product discount. If no, (that is, the member has not reviewed a PIC for the product being purchased), the seller will be notified 110c and the seller will offer no discount to the member.

If the member has a product discount 110d, the system will check if the product discount is still active. If yes 110e, the system will notify the seller as to the amount of the discount. If no 110f, the system will notify the seller that the product discount has expired.

At 110g, the system requests confirmation of the sale which is provided (or not) at 110h. The system will then remove the right of a discount from the member's account 110i.

In addition, the system will enable a feedback questionnaire to be delivered 110j and subsequently send notice to the member account about answering the feedback questionnaire 110k.

Step 7—Request for Feedback Questionnaire

At 120 (FIG. 2G) a member may request a feedback questionnaire whereupon the system will check whether the member qualifies for a feedback questionnaire based on sales transactions recorded in the system 120a and makes the feedback questionnaire available to the member. If the member is ineligible they are notified at 120b.

Step 8—Completing Feedback Questionnaire

After completing the feedback questionnaire (FIG. 2G), the system will check at 130 whether the member has previously earned a credit for completing the feedback questionnaire. If yes, the member is notified at 130a that they have previously earned a credit.

If no, the system checks that the questionnaire has been fully completed 130c.

Step 9—Account Management

If the member successfully completes the feedback questionaire, the member's account is credited a specific amount 140a, and the host account is credited a specific amount 140b (FIG. 2G). As well, the seller's account is debited a specific amount 140c.

Other system functionality can be implemented to enhance the financial operation of the system and options available to visitors and members. These include:

Reconcile Accounts

At the end of the month or at some other interval, it is preferable that all system accounts are reconciled 150 (FIG. 2H).

Display Notices

The system may enable display notices to be shown to members during a web site visit (FIG. 2I). For example, a feedback questionnaire notice 160a or discount notice 160b may be displayed from a PIC screen.

Escrow Account

The system may include system checks to ensure that a supplier's account is above a minimum balance for both reviewing PICs and displaying feedback questionaries 170, 180 (FIGS. 2J,2K). For example, a system check will determine if a PIC account is above a minimum balance 170a and withdraw the PIC from active viewing if the account is not above the minimum amount 170b. A notice to the supplier may be sent 170c and a PIC withdrawal message 170d displayed on the system.

Hardware/Software

In one embodiment, the system uses for example Macromedia's Flash™ technology to produce PICs. Flash™ can provide interactive text, graphics, sound and animation without a high bandwidth and download time requirements thereby maximizing the number of Internet users able to effectively interact with the invention. Preferably, each PIC can be produced and published on the system in two versions simultaneously. One version will employ the most up-to-date and leading edge technologies and will be viewed by users of broadband and sophisticated computers. The second version will adopt a format that would allow the average computer user to interact with the system without excessive download times. As the average computer user upgrades bandwidth, the system will evolve to accommodate the changes. In early stages, the system will assume the following minimum user configuration which represents over 90% of North American computers: Pentium I CPU or equivalent; 32 MB of RAM; 800×600 monitor resolution; an installed Macromedia Flash™ plug-In, and a 28.8 K dial-up Internet connection.

It is preferred that the system provides high reliability, enables scalability, the expansion of functionality, fast processing, ease of maintenance, and ease of interfacing with external systems. In order to achieve these, the following software can be utilized:

1. Operating System: Red Hat Linux 6.2 or a UNIX type/based/related system

2. Web server: Apache (Apache supporting PHP (add in), CGI (built in) and html (built in)).

3. Database: PostgreSQL

4. Dynamic Pages: PHP (Hypertext Pre-Processor) 4

5. DB to HTML Bridge: Mod Fast CGI—written in PERL

Security

The system will also preferably include appropriate security to ensure secure data exchange between the website and the users. Accordingly, it is preferred that pages use encryption with the exception of the visitors' home page. All passwords are stored in the database encrypted with a one-way hash based on the password. Areas of the system that require high security are encrypted with 128-bit encryption. All other areas use 40-bit encryption for performance reasons. All Flash™ animations that are used on the site are protected.

To block users' access, all the information that is passed between flash animations and the database are handled by PERL-CGI scripts. Also, all requests to the CGI scripts are hidden within each Flash™ applet, which the user cannot see or use. For security purposes, the Flash™ Player does not permit access to loaded data outside of the domain. In other words, Flash™ animations that interact with databases only work when served from the CashPick server URL. The applets do not work when used on a different URL.

The site is stored on a Red Hat 6.2—Linux or a UNIX type/based/related system server with password shadows active. All file transfers and remote logins are performed using SSH (secure shell). The server will preferably include a hardware-based firewall as a DMZ (bastion) host and a software-based firewall (IP-chains) allowing ssh and https (tcp) connections. All other ports and protocols are ignored. All malicious attempts that are detected will be logged and the referrers' IP/MAC address will be blocked from the server. As a further precautionary measure, it is preferred that all unused daemon services (such as telnet, finger and ftp) have been disabled and can only be activated by the root (administrator) account. Attempts at connecting to the site via ssh using the root account are denied and logged. Also, less than ten accounts are allowed access to the server via ssh and all of these accounts have strict password rules that are enforced.

User security is preferably enforced with cookies that expire after a predetermined amount of time (eg. 30 minutes) of inactivity. Upon expiry, the user must login again.

The development and production servers will both be patched with all available security updates, as they become available. The entire dynamic content of the site is generated on the server side, using PHP, which will not display any information about how it was generated.

The terms and expressions which have been employed in this specification are used as terms of description and not of limitations, and there is no intention in the use of such terms and expressions to exclude any equivalents of the features shown and described or portions thereof, but it is recognized that various modifications are possible within the scope of the claims.

The embodiments of the invention in which an exclusive property or privilege is claimed are defined as follows:

1. An interactive system for providing product information and rewards to a consumer comprising:
an electronic media element for providing product-specific facts to the consumer;
a question database operatively connected to the electronic media element, the question database engine including:
questions relating to the product-specific facts;
a module for displaying a selection of the questions to the consumer and for receiving and evaluating responses from the consumer to the selection of questions; and,
a reward manager operatively connected to the question database for calculating rewards for the consumer based on the responses received to the selection of questions.

2. An interactive system as in claim 1 wherein the rewards are any one of or a combination of a cash credit to the consumer or a discount credit for subsequent purchase of a product.

3. An interactive system as in claim 1 further comprising a product sale module operatively connected to the reward manager, the product sale module for receiving rewards data from the reward manager and reporting the rewards data to a seller of a product operatively connected to the product sale module whereby the seller provides a discount to the consumer if the consumer has appropriate reward data for the product being purchased.

4. An interactive system as in claim 1 further comprising a post-sale module operatively connected to the reward manager, the post-sale module for providing a post-sale questionaire to a consumer and for receiving responses from the consumer to the post-sale questionaire, the post-sale module also for reporting completion of the post-sale questionaire to the reward manager for calculating a reward for the consumer specific to completing the post-sale questionnaire.

5. An interactive system as in claim 1 further comprising a membership module operatively connected to the electronic media element, the membership module for receiving and managing member data and for controlling access to the question database.

6. An interactive system as in claim 5 wherein the membership module defines at least two levels of membership, a first level allowing access to the electronic media element and the second level allowing access to the question database.

7. An interactive system as in claim 1 further comprising a seller account for holding seller funds operatively connected to the reward manager wherein the seller account is debited when the reward manager provides a reward to the consumer.

8. An interactive system as in claim 5 further comprising a membership referral module operatively connected to the membership module and the reward manager for providing referral data to the reward manager.

9. An interactive system as in claim 2 further comprising a product sale module operatively connected to the reward manager, the product sale module for receiving rewards data from the reward manager and reporting the rewards data to a seller of a product operatively connected to the product sale module whereby the seller provides a discount to the consumer if the consumer has appropriate reward data for the product being purchased.

10. An interactive system as in claim 9 further comprising a post-sale module operatively connected to the reward manager, the post-sale module for providing a post-sale questionnaire to a consumer and for receiving responses from the consumer to the post-sale questionnaire, the post-sale module also for reporting completion of the post-sale questionnaire to the reward manager for calculating a reward for the consumer specific to completing the post-sale questionnaire.

11. An interactive system as in claim 10 further comprising a membership module operatively connected to the electronic media element, the membership module for receiving and managing member data and for controlling access to the question database.

12. An interactive system as in claim 11 wherein the membership module defines at least two levels of membership, a first level allowing access to the electronic media element and the second level allowing access to the question database.

13. An interactive system as in claim 12 further comprising a seller account for holding seller funds operatively connected to the reward manager wherein the seller account is debited when the reward manager provides a reward to the consumer.

14. An interactive system as in claim 11 further comprising a membership referral module operatively connected to the membership module and the reward manager for providing referral data to the reward manager.

15. A method for providing product information and rewards to a consumer comprising the steps of:
a) providing an electronic media element containing product-specific facts to the consumer;
b) determining a selection of questions relating to the product-specific facts and providing the selection to the consumer;
c) receiving and evaluating answers to the selection of questions from the consumer;
d) crediting a consumer account with a reward if a pre-determined number of questions from step b) were correctly answered.

16. A method as in claim 15 wherein the reward is any one of or a combination of a cash credit to the consumer or a discount credit for subsequent purchase of a product.

17. A method as in claim 15 further comprising the step of applying a discount credit from the consumer account against the purchase price of a product.

18. A method as in claim 15 further comprising the step of crediting the consumer account with a reward if the consumer completes a post-sale questionnaire.

19. A method as in claim 16 further comprising the step of applying a discount credit from the consumer account against the purchase price of a product.

20. A method as in claim 19 further comprising the step of crediting the consumer account with a reward if the consumer completes a post-sale questionnaire.
